(19) United States
(12) Patent Application Publication
(10) Pub. No.: US 2007/0220264 A1
(43) Pub. Date: Sep. 20, 2007

(54) AUTOMATED METHOD, SYSTEM, AND PROGRAM FOR AIDING IN PRODUCT COMPLIANCE AND ADHERENCE

(75) Inventors: Eric Edwards, West Henrietta, NY (US); Christopher Mann, Pittsford, NY (US); Jacqueline Parks, Honeoye Falls, NY (US)

Correspondence Address: HULSEY IP INTELLECTUAL PROPERTY LAWYERS, P.C., 1250 S. CAPITAL OF TEXAS HIGHWAY, BUILDING THREE, SUITE 610, AUSTIN, TX, 78746, US

(73) Assignee: Voiceport, LLC

(21) Appl. No.: 11/564,282

(22) Filed: Nov. 28, 2006

Related U.S. Application Data
(60) Provisional application No. 60/740,177, filed on Nov. 28, 2005.
(60) Provisional application No. 60/740,182, filed on Nov. 28, 2005.

(51) Int. Cl. H04L 9/00

(52) U.S. Cl. 713/176

(57) ABSTRACT

The disclosed subject matter can determine the information to be communicated to the third party from the client. The third parties are instructed to contact the service provider to collect their contact information. The contact information collected is sued as a basis for follow up calls to insure compliance and adherence to the product.

This application claims the benefit of priority to U.S. Provisional Patent Application No. 60/740,177 entitled “PERSONA-DRIVEN METHOD FOR COMPILING ADVERTISING DATA USING VOICE INTERFACE SYSTEM,” by Eric Edwards filed on Nov. 28, 2005, and is incorporated herein by reference as if fully set forth herein. This application also claims the benefit of priority to U.S. Provisional Patent Application No. 60/740,182 entitled “METHOD FOR COMPILING ADVERTISING DATA USING VOICE INTERFACE SYSTEM,” by Eric Edwards filed on Nov. 28, 2005, and is incorporated herein by reference as if fully set forth herein.

This application incorporates by reference the co-pending patent application entitled “AUTOMATED METHOD, SYSTEM, AND PROGRAM FOR AIDING IN PRODUCT ADVERTISEMENT”, by Eric Edwards filed on Nov. 28, 2006, and is incorporated herein by reference as if fully set forth herein.

This application incorporates by reference the co-pending patent application entitled “AUTOMATED METHOD, SYSTEM, AND PROGRAM FOR GENERATION OF AN AUDIO SURVEY”, by Eric Edwards filed on Nov. 28, 2006, and is incorporated herein by reference as if fully set forth herein.

This application incorporates by reference the co-pending patent application entitled “AUTOMATED METHOD, SYSTEM, AND PROGRAM FOR AIDING IN STRATEGIC MARKETING”, by Eric Edwards filed on Nov. 28, 2006, and is incorporated herein by reference as if fully set forth herein.

### TECHNICAL FIELD OF THE DISCLOSED SUBJECT MATTER

The disclosed subject matter relates to providing customer service after a third party has bought a client's product. More specifically, the disclosed subject matter deals with aiding the client in promoting use of the product or service in the correct manner. The disclosed subject matter also stresses adherence to the product after enough time passes when the third party no longer perceives a need for the product.

### BACKGROUND OF THE DISCLOSED SUBJECT MATTER

A problem with certain products that are used on a repetitive basis comes from those who purchase the product not using the product properly. Until the third party becomes used to following the manufacturer's instructions, third parties forget to do as they were advised when they first purchased the product. Once the third party has gotten used to acting in accordance with the instructions, they are less likely to forget, but that takes time.

Another problem with product sales after the initial impetus to purchase the product has passed comes from customers believing they no longer need the product. Perceiving no more need for the product, third parties may stop using the client's product and by extension stop purchasing said product.

Third parties that misuse a product, arbitrarily stop using the product, or simply forget to use the product represent a serious financial loss to the client. These lost sales might individually be small, but when compounded over the years of potential product use, every third party could represent a large financial loss if not addressed by the client.

Communication between the client and the third party increase compliance and adherence, but such contact has not always been feasible. Obstacles to communication include identifying the third parties and establishing a mechanism to communicate between the client and the third party.

There might be no direct link between the client and the third party during the product sale for various reasons. Without some form of initial contact between the client and third party, the service provider may never establish a link with the third party.

When confronted with the need to communicate with third parties on a time sensitive basis, telephone calls offer a considerable advantage to other modes of communication such as direct mail or in person reminders. Use of the telephone does offer some drawbacks. Telephone calls take a large staff to make the number of calls necessary to contact all the third parties. Companies could have employees make these calls, but those employees could perform other needed duties. The client could contract the responsibility to call centers, but that becomes expensive. This commitment of resources makes telephone calls prohibitive for all but large companies to make follow up calls. Even large companies might find it economical to use telephone calls only on high value items.

Clients need a way to get the information out to third parties with a minimal amount of expense. An automated system allows clients of all sizes the ability to effectively communicate with third parties by telephone to promote product compliance and adherence.

The disclosed subject matter addresses these issues. The disclosed subject matter can determine the information to communicate to the third party from the client. The service provider obtains contact information for the third parties. The third parties then receive follow up calls from the service provider about the client's product.

### SUMMARY OF THE DISCLOSED SUBJECT MATTER

The method and system illustrated and described herein have several features, no single one of which is solely responsible for its desirable attributes. Without limiting the scope as expressed by the description that follows, its more prominent features will now be discussed briefly. After considering this discussion, and particularly after reading the section entitled “DETAILED DESCRIPTION OF THE ILLUSTRATIVE EMBODIMENTS” one will understand how the features of the disclosed subject matter provide for the analysis of source code.

The disclosed subject matter provides method and system for aiding in product adherence and compliance. While the present disclosed subject matter can be applied to numerous applications, this application will illustrate the patent as applied to the pharmaceutical industry as an example. The disclosed subject matter will provide a service of follow up calls, as directed by the client to third parties.

The disclosed subject matter can determine the information to communicate to the third party from the client. The service provider obtains contact information for the third parties. The third parties then receive follow up calls from the service provider about the client's product.

A component of the disclosed subject matter involves defining the product information to communicate to third parties. The disclosed subject matter collects the information in several ways. One method involves the client interacting with an automated system. The method and system would determine how to categorize the product. The method and system would ask the client a series of questions to determine the content of the automated call. In this example, the method and system would be defined as a pharmaceutical. The basis of the following questions comes from commonly asked questions involved in initial and follow up calls in the applicable field. Other information gathered includes the frequency of contact with the third parties.

Alternatively, a personal service agent of the service provider can collect initial information along with the compliance and adherence parameters to craft a unique compliance and adherence call structure as opposed to a standardized one. Customization allows the client greater flexibility in the service. Other alternatives include the client creating all their own information parameters and having the service provider simply provide the delivery vehicle.

Upon establishing the content of the follow up calls the system processes the information into an audio message with a particular persona. An example would include a stereotypical mechanic with perhaps some garage sounds in the background if the product deals with automotive issues. Another example would use a nurse at a hospital asking health related questions, as in the case of a pharmaceutical product. There would be no limit to the number of personas available. Other alternatives allow the voice used in the calls to come from a particular voice actor as opposed to a standard voice offered by the service provider.

Once the information has been complied, the service provider begins to interact with the third parties. With the third party acquisition of the client's product, the third party receives a phone number to call. When the number is called, the third party supplies basic information, including contact information. Once this call is completes, the service provider now has the contact information necessary to conduct a follow up contact. Alternatively, the client might be able to provide the third party contact information.

For the purpose of follow up contacts, phones will be used as an example. Other forms of communication are possible, including but not limited to e-mail and text messaging.

Follow up contacts are another aspect of the disclosed subject matter. One type of follow up contact is the compliance call. While this can be modified for any product, an illustrative example will be a medication that must be taken once per day.

After the service provider receives third party contact information, the service provider looks to see what compliance calls the client selected for the medication. The example calls for a daily follow up call by the service provider. The service provider makes the call at a predetermined time everyday. When the third party answers, the service provider relays the applicable information over the phone. An example would be, “Remember to take you medication today.” There could be other information added such as whether or not to take it with food or other issues as applicable.

The client might not wish for such calls to be made as often after a predetermined period of time. The client has the option to specify when they would like to have the call intervals increased. An example would be a weekly or monthly call as opposed to a daily reminder. The information related could remain the same as the weekly call, or again modified per client direction.

The second type of follow up call is the adherence call. A common issue clients encounter with third parties who purchase their product comes from third parties not continuing to buy their product through apathy, forgetfulness, or other reasons while the reason they originally bought the product remain valid. Adherence calls would act as a reminder not on how to use the product, but that the need for the product could still exist. Adherence calls would be made at predetermined times based on issues such as expected prescription refill times, times of year where the medication might do the most good, or other issues as determined by the client.

A factor for consideration when generating the calls is the length of the individual call and the number of follow up calls made. The disclosed subject matter can approximate how long each call will take. This could be a relevant factor for cost purposes or for optimum use of the follow up call service. One embodiment of the disclosed subject matter offers the service by charging per minute of phone time used by the client. The client might want to consider the trade off of using a more calls with shorter messages or more calls with longer messages.

### BRIEF DESCRIPTION OF DRAWINGS

The accompanying drawings, which are incorporated in and constitute a part of this specification, illustrate several embodiments of the invention and together with the description, serve to explain the principles of the invention.

FIG. 1 presents a general overview of the disclosed subject matter. The information is collected by the service provider from the client. The service provider then receives third party contact information. The service provider gives the third party information on the product, followed up by compliance and adherence calls;

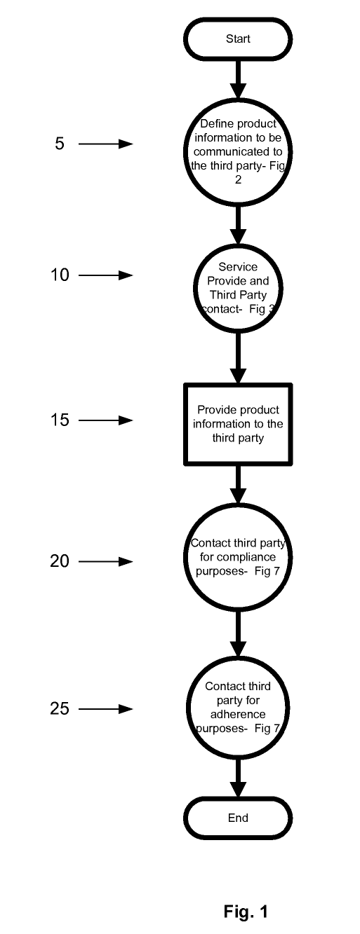

FIG. 2 shows the mechanics of using an automated system for message generation. The information is collected by the service provider from the client and converted into an automated message of an appropriate type;

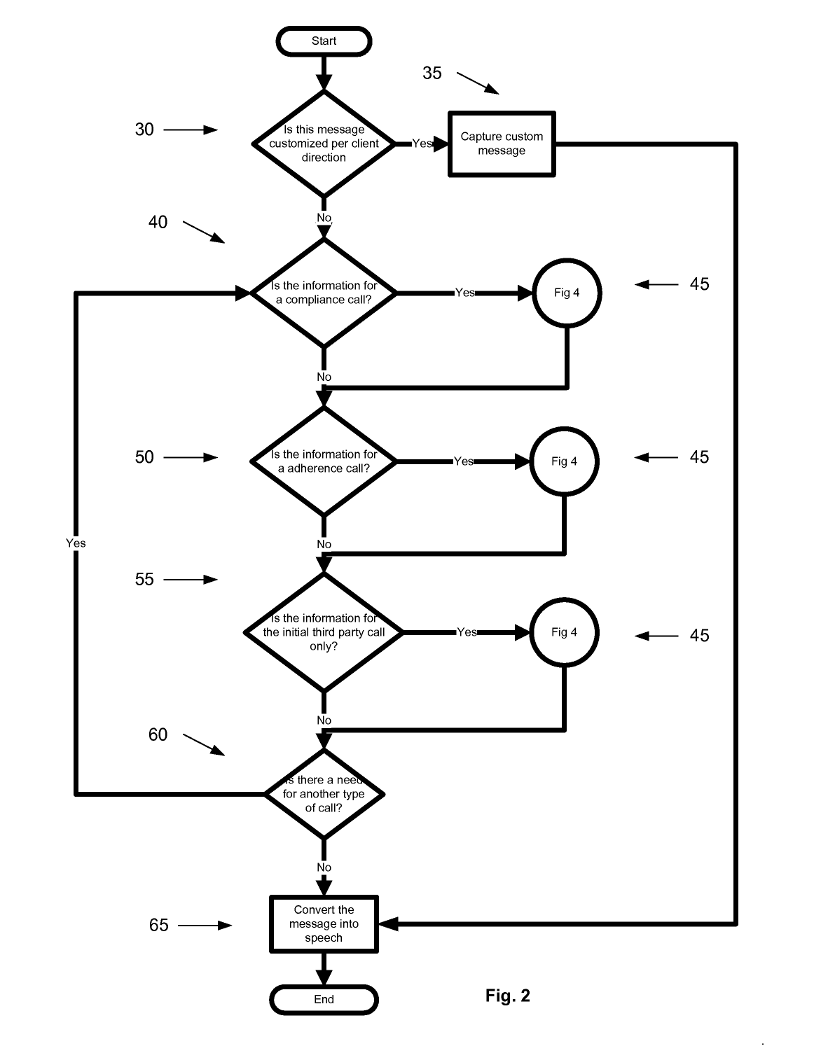

FIG. 3 depicts how the service receives the third party contact information;

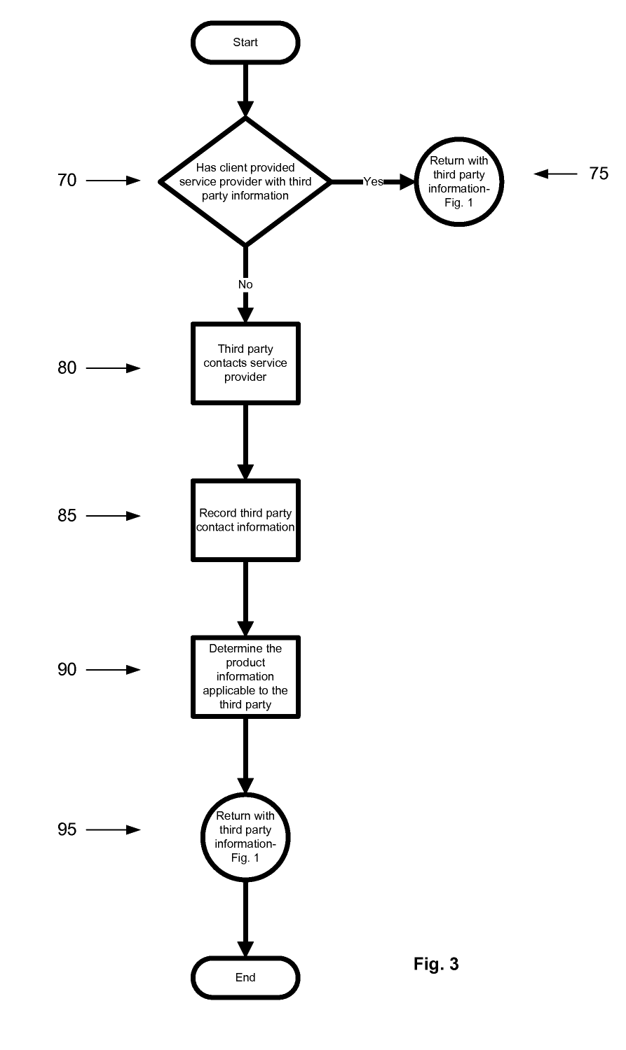

FIG. 4 shows how the follow up call parameters are established, including information collection and recurrence of the calls;

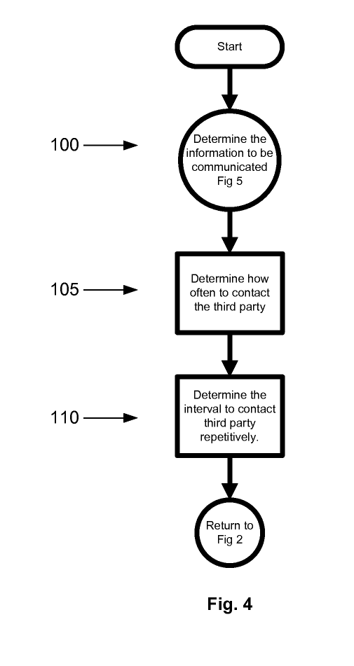

FIG. 5 is an algorithm useful for generating the message;

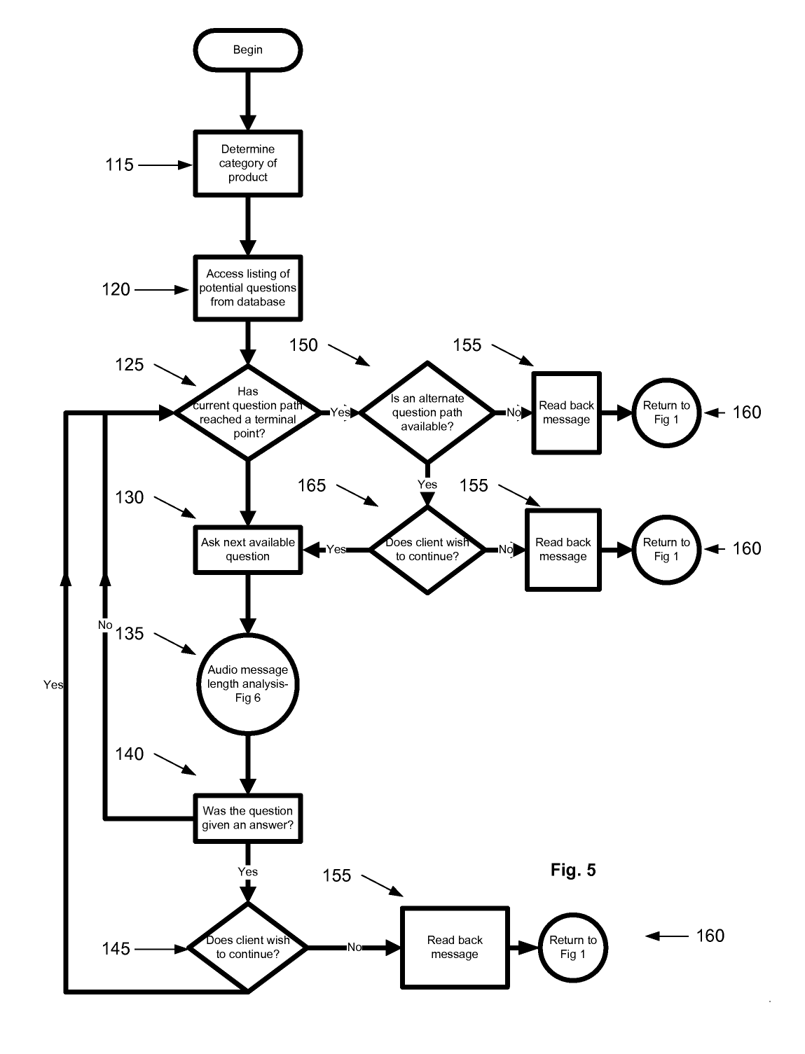

FIG. 6 provides an audio length analysis algorithm, for use in one embodiment where message length is a factor of concern; and

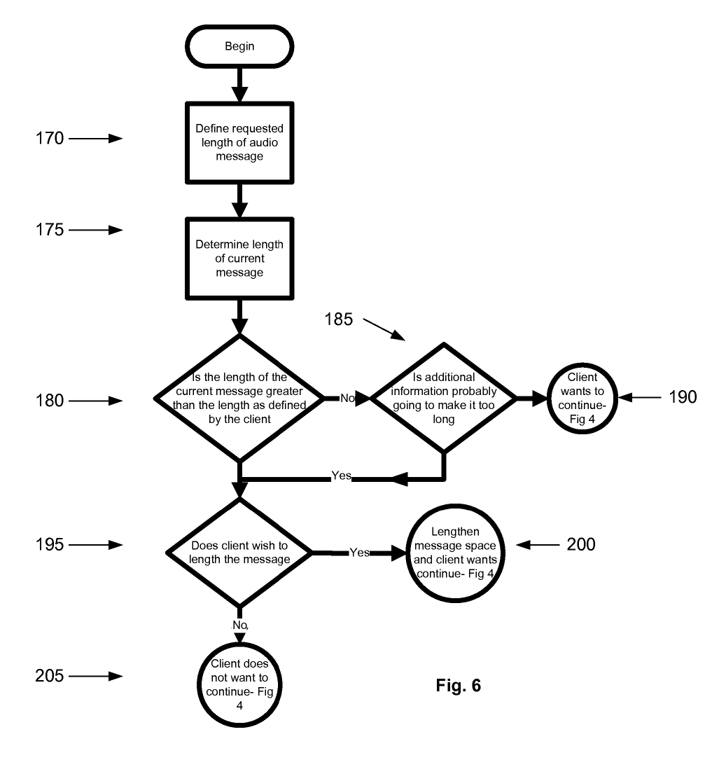

FIG. 7 shows the interactive component of the follow up calls.

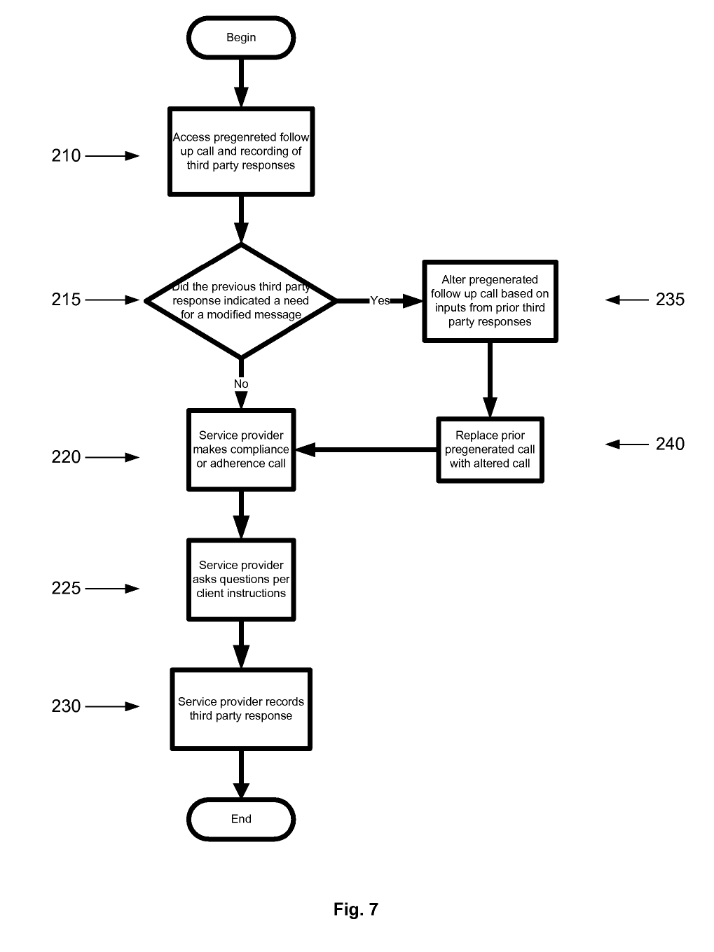

### DETAILED DESCRIPTION OF PREFERRED EMBODIMENTS

The disclosed subject matter can determine the information to communicate to the third party from the client. The service provider obtains contact information for the third parties. The third parties then receive follow up calls from the service provider about the client's product.

Although described with particular reference to a systems environment, the claimed subject matter can be implemented in a plurality of information technology (IT) systems. Those with skill in the electronic telecommunications arts will recognize that the disclosed embodiments may be realized in ways in addition to those specific examples described below. In addition, the methods of the disclosed subject matter can be implemented using a variety of combinations of software and hardware. The hardware portion can be implemented using specialized logic; the software portion can be stored in a memory and executed by a suitable instruction execution system such as a microprocessor, PC or mainframe.

All references, including publications, patent applications, and patents, cited herein are hereby incorporated by reference to the same extent as if each reference were individually and specifically indicated to be incorporated by reference and were set forth in its entirety herein.

In the context of this document, a “memory” can be any means that contains, stores, communicates, propagates, or transports the program and/or data for use by or in conjunction with an instruction execution system, apparatus or device. Memory, recording medium and data store can be, but are not limited to, an electronic, magnetic, optical, electromagnetic, infrared or semiconductor system, apparatus or device. Memory, recording medium and data store also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

The disclosed subject matter may be described in the general context of computer-executable instructions, such as program modules, being executed by a computer. Generally, program modules include routines, programs, objects, components, data structures, etc. that performs particular tasks or implement particular abstract data types. The disclosed subject matter may also be practiced in distributed computing environments wherein tasks are performed by remote processing devices that are linked through a communications network. In a distributed computing environment, program modules may be located in local and/or remote computer storage media including memory storage devices.

Preferred embodiments of this disclosed subject matter are described herein, including the best mode known to the inventors for carrying out the disclosed subject matter. Variations of those preferred embodiments may become apparent to those of ordinary skill in the art upon reading the foregoing description. The inventors expect skilled artisans to employ such variations as appropriate, and the inventors intend for the disclosed subject matter to be practiced otherwise than as specifically described herein. Accordingly, this disclosed subject matter includes all modifications and equivalents of the subject matter recited in the claims appended hereto as permitted by applicable law. Moreover, any combination of the above-described elements in all possible variations thereof is encompassed by the disclosed subject matter unless otherwise indicated herein or otherwise clearly contradicted by context.

Although the present disclosed subject matter has been described in detail herein with reference to the illustrative embodiments, it should be understood that the description is by way of example only and is not to be construed in a limiting sense. It is to be further understood, therefore, that numerous changes in the details of the embodiments of this disclosed subject matter and additional embodiments of this disclosed subject matter will be apparent to, and may be made by, persons of ordinary skill in the art having reference to this description. It is contemplated that all such changes and additional embodiments are within the spirit and true scope of this disclosed subject matter as claimed below.

The disclosed subject matter generates a series of audio messages for clients to communicate with third parties about a client's product. The disclosed subject matter incorporates certain rules and patterns that have been observed in the structure of information communicated to third parties by clients with additional intelligence from external sources of sales-item data. This methodology provides the algorithmic basis of the message generation process along with the messages themselves. The current disclosed subject matter utilizes state of the art voice user interface techniques to provide a comfortable and intuitive interaction with the client and third parties. Although the current disclosed subject matter may find a use for any product or service that would benefit from such contact, the exemplary discussion herein will focus on compliance and adherence calls in the pharmaceutical industry.

The current disclosed subject matter includes a way to capture client information for creating an audio message. The purpose of the disclosed subject matter is to gather information about the client's product and thereby build information and follow up calls. The information received for call generation come from the client using any source, including telephone and web based systems. For example purposes, audio input generation will be used to create audio messages, while alternatives such as web based format remain available. For example purposes, communication with third parties can use any medium, including telephone and web based systems.

In the example used in this description, the embodiment would involve the product manufacturer being a client of a service provider. Alternatively, the service can be provided by the company who wants the calls made by an in-house department. Moreover, the client and the service provider can be one in the same.

The system defines the information to communicate to third parties 5. The disclosed subject matter uses an algorithm to generate such information from the client or the client can directly create the message.

Once the client's message is generated, the service provider needs to be able to contact the third party. This contact information can come from anywhere 10. When the third party makes contact with the service provider, the information can be collected. Said information is then relayed to the applicable third parties 15.

The next call available in the embodiment would be the follow up call 20. In the disclosed embodiment, the follow up call times are predetermined at the time of the original call parameter generation. In the example embodiment, the client can set the predetermined time intervals as a function products information loaded into the knowledge base. An example would be a compliance call. This call would be made at regular intervals in the early days after the initial contact with the third party. The compliance call could provide basic information such as how to properly take the medication.

Another example of a follow up call in this embodiment would be the adherence call 25. Adherence calls generally use longer calling intervals than compliance calls. Adherence calls remind third parties to continue to use the product

An aspect used in some embodiments of the disclosed subject matter to generate the questions and responses comes from the use of a database. This database can contain information for a plurality of possible products that use the disclosed subject matter. The database contains information on what the typical questions clients ask a third party and other information to aid in message generation. The information comes from research into what the common information exchanged between the client and third party typically contains. This database also contains a bank of automated prompts and outputs that the client can control dynamically based on the particular embodiment.

An alternative embodiment allows the client to customize their messages by directly providing the service provider with exactly what the client wants the messages to communicate without use of the database. The alternative would allow the client the ability to select exactly what they want the messages to say and also ask very specific questions. Another alternative available to the client would use personal contact with the service provider. This would allow a collaborative process where both parties come up with a particular set of inputs and outputs for the messages.

Before communication begins with the third party, the system collects information to be communicated. If the client chooses a customized set of questions and responses 30, the service captures the information 35 and converts it into an audio format 65. If the client does not use a customized message, then the information begins for different call types.

With the information to communicate, the system categorizes what type of call the information belongs to. When the client uses the service, the client makes selections when generating the message that determine what type of call to use with the information. In this embodiment, the message generation splits into three types, although more can be added in other embodiments. The categories are compliance calls, adherence calls, and information calls 40, 50, 55. All three types of call are capture information using the same method 45. The process of information capture repeats until all the information is collected 60.

Once all of the information is collected, the system converts the message into an audio format 65. The audio format takes on one of a number of personas. The persona used for the message relates to the type of information being communicated. These personas suggest attributes of the speaker that foster creditability in what the message says. Examples include a nurse dispensing medical information, a mechanic talking about a car, a lawyer talking about legal issues, or a pollster asking about how a person plans on voting. Optional sounds include background noises, such as the sound of a hospital in the background for a nurse, or sounds of a garage for a mechanic.

An alternative to the use of a particular persona would be the use of a specified voice actor. This could allow more customization to the client.

The disclosed subject matter makes contact with third parties. The method and system needs the applicable contact information to initiate the calls 70. In some embodiments, the client might already have the applicable third party contact information and have provided it to the service provider. If so, no more data collection is needed 75. In the example used for illustrative purpose, the service provider does not start with the third party's contact information. In this context, the third party would have to initiate contact with the service provider in order for the service provider to get the third party contact information 80.

The impetus for the third party to call the service provider comes from any source. Examples include notice provided by a doctor or contact information printed on the side of the product used by the third party. Advertisements in the media could also spur third parties to call the service provider.

When the third parties initially make contact with the service provider, the service provider needs to have a method of collecting the third parties contact information if not previously recorded 85. One method of doing so involves the use of caller ID or a similar service. Another method that allows for more certainty of recording the correct information comes from asking the third party to supply their information to the system. This allows for the service provider to initiate future calls.

As previously mentioned, there are several types of call made in this embodiment. When the client selects an information call, the client will select information to communicate about the product. Examples include general information collected by the system, such as how often the medication be taken. The lists possible information to communicate to a third party are potentially infinite.

In the example embodiment, the third party makes the initial call to the service provider. During this call, the service provider collects the third party's contact information. The service provider also determines which product the third party uses 90. The system now has recorded the information applicable to the third parties 95. The initial call made by the third party communicate selected information on the client's product as defined in the aforementioned information call. In this embodiment, the system can also create follow up calls for information purposes that provide additional information to the third party as the client deems it necessary to inform the third party.

When a client selects a follow up call, either a compliance call or an adherence call, the disclosed subject matter acts in much the same manner. With a compliance call, the disclosed subject matter interrogates the client as to the information to provide to the third party 100. Examples include a simple reminder to take the medicine at a particular time, to a more complex statement such as taking the medication on an empty stomach. The method and system then asks the time interval used between calls and the duration of service use 105. The disclosed subject matter can use any interval and to repeat every set amount of time until the termination event 110. An example might be to call once a day for two weeks.

A second form of follow up call is the adherence call. As with the compliance call, the disclosed subject matter interrogates the client as to the information to provide 100. Examples of the possible information to communicate include a reminder to refill the prescription for the medication to more complex statements such as reminders to the third party about the underlying reason for the medication. The disclosed subject matter then asks the time interval 105 to use and the duration of the service. The service repeats every set amount of time until a termination point is reached 110. An example in this case could be once a month or every three months as medication refills are needed.

Embodiments exist that introduce a confirmation to the follow up calls. At the beginning of the call, the system asks the third party a question where the third party's answer can be compared against information known to the service provider. Examples of questions include confirmation of the third party's name or confirmation the third party uses a specific product. Once the system confirms the identity of the third party per the embodiment, the follow up call begins.

When generating the message, the service has a list of standard questions and prompts available. As the disclosed subject matter begins in the described embodiment, the client receives a query for basic details about the product. In this example, the category would be something similar to ‘medication’. The product classification returns a series of relevant and appropriate prompts, which ask the client to select from this list of the product's criteria based on the classification. The prompts over the telephone system are designed to be conversational and direct, and therefore will elicit responses that are natural to the caller and, likely to be recognized by the system. Alternatively, some responses accept input on the telephone keypad.

The system approaches the information collection for the message in a predetermined manner. For message generation, the following example will describe a possible algorithm used to collect information from the client. These bullets denote the information that is initially collected from the client in order to categorize the message 115:
Type of product (Medication)
Type of medication (allergy, heart)
Sub-classification of medication (“decongestant, fever reducer”)

Next, the initially collected information is used to select a capture profile specific to the product from the applicable knowledge base. The capture profile consists of a series of capture items that are presented to the caller in sequence to collect additional information about the product. Examples of capture items are 120:
Medication name
Reason to take the medication
Recommended dosage
Recommended schedule
Notes
Warnings

The general algorithm repeats until a termination condition is met. The answers to questions drive the subsequent question paths. The system asks questions that have not been asked remaining in the capture profile along said resulting path of questioning 125. If so, the system will present the question to the client 130. After the question is asked, the system then analyzes the entire message for audio message length 135. If no answer to the question was given, the system goes to see if the question has reached a terminal point 140. If the client does not wish to continue with the questions 145, the process completes with the message being read back 155 and the message generates 160. Once a path of questions has been exhausted, the system looks to see if an alternate path of questioning exists 150. If there is no available alternate path, the system reads back the message at that time 155 and generates the message 160. When an alternate path exists, the system asks if the client wishes to continue 165. If so, the system continues with the new question list 130. If not, the system reads back the message 155 and generates the message 160.

The system confirms with the client every piece of information. Failure to confirm or collect a piece of information (for example, repeatedly failing to recognize their last name) results in the caller being transferred to an agent or another alternate based on the embodiment.

An optional aspect of the disclosed subject matter relates to the cost of the service. Some embodiments of the service give the client the option to limit the cost of the service provided by making the cost of the call fall within a set price boundary 170 in embodiments that charge for the service per the amount of time for each call. In doing so, the system will define the amount of time that is applicable to the client wants to spend. This can be used to determine if the message can be lengthened or needs to be reduced.

The system calculates audio message length by use of an algorithm, converting the message into audio format, or other method to those known in the art to determine the resulting message length 175. Based on the returned price of the message, the system will do one of the following:
Check the length of the message and see if it is within the amount paid for 180.
If the most recently added item has raised the price for the message notify the client that the item does not fit 195. Read the message text back and query if they would like to include the most recent item and possibly more in the message and raise the limit on the price. If they select more 200, then the process continues. If they choose not to purchase more, then the advisement is concluded 205.
If there is likely additional time available at the current price quoted initially 185 move on to the next capture item 190.
If the message does not likely have additional time at the current price 185, read the message text and current price back to the customer and query if they would like to include more in the message and raise the limit on the price call 195.

The algorithm continues until the content of the message meets the client's requirements or all capture items have been presented. The system reads the message back to the client for verification.

An option available for the follow up calls introduces an interactive component. When the system makes a follow up call, it accesses the applicable call and a memory file of the responses to previous calls to the third party 210. The system determines if any of the responses to the previous calls would qualify as a reason to modify the current call, and if so how much to change the call 215. If there is not reason to make a change, the service provider makes the call 220 based on the prior pregenerated audio message. During the call, the system queries to the third party about the relevant information 225. An example could be, “how many times have you missed your medication in the past week?” The system records the responses 230. The responses are accessed by the system before the next call is made to the third party.

In the event the previous third party response indicates a need to change the message based on the knowledge base 215, the system alters the message 235 and replaces the previously pregenerated message with an updated message 240. The service provider then makes the call as it would with any other follow up call. An example of the previously recorded information modifies the next message by saying, “In the past you missed your medication, and hopefully you suffered no ill effects as a result.”

As the use of follow up calls progress over the projected lifetime of product use, the need for follow up calls generally diminishes. The follow up calls may be made less frequently as the third parties generally have become used to following the directions for the product. The system embodiment can be established to change the intervals between calls. After a predetermined amount of time, the interval can change to a second interval different from the original interval.

Another option for the system allows for the capture of billing information. The system checks the customer database for a matching account using the client's name and number. If there is an associated account then the address in the account is confirmed with the caller. Failure to confirm the existing account address will cause the caller to go to an agent. If there is no account then the system collects the caller's address from the caller and creates a new account. In both cases, the message is saved.

If there is no account and collecting the address for the new account fails then a new account is made with the unknown fields marked as incomplete and the message is saved. The caller is then transferred to an agent. During the transfer, the agent is informed (via whisper) that the message has been saved but the name and address fields are incomplete.

The disclosed subject matter described herein is a fundamentally novel method and system. By facilitating the collection of information to communicate to third parties on behalf of clients, a service provider can aid a client in promoting the proper use of the client's product. Further by maintaining contact information for the third parties, the service provider can aid the client by communicating with third parties in such a way that promotes proper and continued use of the client's product with a minimal amount of labor on the part of the client. Following a standardized algorithm, the messages are generated in a manner that facilitates easy communication over communications medium that effectively communicates the information in a creditable manner to the third parties.

Various changes and modification to the embodiments herein were chosen for the purposes of illustration will readily occur to those skilled in the art. To the extent that such modifications and variations do not depart form the spirit of the invention, they are intended to be included within the scope thereof which is assessed only by fair interpretation of the following claims.

What is claimed is:

1. A method for a service provider to supply a third party with information on the client's medical product with an automated message, comprising the steps of:
defining the client's medical product information to be communicated to the third party;
collecting information about the third parties to be contacted; and
communicating with the third party as to the proper use of the client's product at predetermined times of a predetermined duration.

2. The method of claim 1 for communicating further comprising a in audio message using a predetermined vocal persona.

3. The method of claim 1 of providing said third party with said product information, further comprising the steps of:
accessing a knowledge base associated with the communicated information;
asking the client questions; and
creating a message based on responses to said questions asked.

4. The method of claim 3 of providing said third party with said product information, further comprising the steps of:
converting the message into an audio format with a predetermined vocal persona;
determining the vocal persona based on the knowledge base; and
transmitting said audio formatted message.

5. The method of claim 1 for creating an automated message, further comprising the steps of:
receiving inputs from the client as to the information to communicate;
receiving inputs from the client as to set a predetermined time to make contact; and
creating the message based on the client's inputs.

6. The method of claim 1 for a service provider to provide a third party with said client's medical product information, further comprising the steps of setting the predetermined times for future calls.

7. A method for a service provider to supply a third party with information on the client's product with an automated message, comprising the steps of:
defining the client's product information to be communicated to the third party;
collecting information about the third parties to be contacted; and
communicating with the third party as to the proper use of the client's product at predetermined times of a predetermined duration.

8. The method of claim 7 for communicating further comprising a in audio message using a predetermined vocal persona.

9. The method of claim 7 of providing said third party with said product information, further comprising the steps of:
accessing a knowledge base associated with the communicated information;
asking the client questions; and
creating a message based on responses to said questions asked.

10. The method of claim 9 of providing said third party with said product information, further comprising the steps of:
converting the message into an audio format with a predetermined vocal persona;
determining the vocal persona based on the knowledge base; and
transmitting said audio formatted message.

11. The method of claim 7 for creating an automated message, further comprising the steps of:
receiving inputs from the client as to the information to communicate;
receiving inputs from the client as to set a predetermined time to make contact; and
creating the message based on the client's inputs.

12. The method of claim 7 for a service provider to provide a third party with said client's product information, further comprising the steps of setting the predetermined times for future calls.

13. A system for a service provider to supply a third party with information on the client's product with an automated message over a communications system, comprising:
a general purpose computer capable of executing a portion of the an instruction set of a software product;
a software product where the software product controls a general purpose computer performing the following instruction sets:
defining the client's product information to be communicated to the third party;
collecting information about the third parties to be contacted; and
communicating with the third party as to the proper use of the client's product at predetermined times of a predetermined duration.

14. The system of claim 13 where said system contains instructions for communicating further comprising use of an audio message using a predetermined vocal persona.

15. The system of claim 13 of providing said third party with said product information, where said system contains instructions for:
accessing a knowledge base associated with the communicated information;
asking the client questions; and creating a message based on responses to said questions asked.

16. The system of claim 15 of providing said third party with said product information, where said system contains instructions for:
converting the message into an audio format with a predetermined vocal persona;
determining the vocal persona based on the knowledge base; and
transmitting said audio formatted message.

17. The system of claim 13 for creating an automated message, where said system contains instructions for:
receiving inputs from the client as to the information to communicate;
receiving inputs from the client as to set a predetermined time to make contact; and
creating the message based on the client's inputs.

18. The system of claim 13 where said system contains instructions for a service provider to provide a third party with said client's product information, further comprising the steps of setting the predetermined times for future calls.

19. A computer usable medium having a computer readable program code means embodied therein for a manufacturer to supply a third party with information on the client's product with an automated message, the computer usable medium comprising:
a computer readable program code means for defining the client's product information to be communicated to the third party;
a computer readable program code means for collecting information about the third parties to be contacted; and
a computer readable program code means for communicating with the third party as to the proper use of the client's product at predetermined times of a predetermined duration.

20. The computer usable medium of claim 19 for communicating further comprising a in audio message using a predetermined vocal persona.

21. The computer usable medium of claim 19 of providing said third party with said product information, further comprising the steps of:
accessing a knowledge base associated with the communicated information;
asking the client questions; and
creating a message based on responses to said questions asked.

22. The computer usable medium of claim 21 of providing said third party with said product information, further comprising the steps of:
converting the message into an audio format with a predetermined vocal persona;
determining the vocal persona based on the knowledge base; and
transmitting said audio formatted message.

23. The computer usable medium of claim 19 for creating an automated message, further comprising the steps of:
receiving inputs from the client as to the information to communicate;
receiving inputs from the client as to set a predetermined time to make contact; and
creating the message based on the client's inputs.

24. The computer usable medium of claim 19 for a service provider to provide a third party with said client's product information, further comprising the steps of setting the predetermined times for future calls.

25. An automated method to supply information on a product, the method comprising the steps of:
reviewing information relating to an end user's use of a product, wherein the end user is targeted to be contacted based on that use;
gathering information based on the reviewed information regarding an end user's use of a product to be communicated to the end user; and
communicating to the end user gathered information relating to proper use of the product via an automated message system, wherein the gathered information is communicated to the end user at predetermined intervals for a predetermined duration.

26. The method of claim 25, wherein the step of gathering information further comprises at least one of collecting the data from a party manufacturing the product, a party selling the product, a party promoting a product, or a party purchasing the product for resale.

27. The method of claim 25, wherein the communicating step further comprises, an audio message using a predetermined vocal persona.

28. The method of claim 25, wherein the step of gathering information, further comprises the steps of:
accessing a knowledge base based on the reviewed information;
associating reviewed information with appropriate dialogue from the knowledge base, and;
creating a message based on gathered information.

29. The method of claim 25, wherein the method further includes the steps of:
accessing information gathered on the product's use;
determining times for future contacts based on the accessed information; and
creating the message based on said accessed information.

30. A system to supply information on a product, comprising:
a general purpose computer capable of executing a portion of an instruction set of a software product;
a software product resident on a general purpose computer, wherein the software product is capable of directing the general purpose computer to perform the following instruction set:
reviewing information relating to an end user's use of a product, wherein the end user is targeted to be contacted based on that use;
gathering information based on the reviewed information regarding an end user's use of a product to be communicated to the end user; and
communicating to the end user gathered information relating to proper use of the product via an automated message system, wherein the gathered information is communicated to the end user at predetermined intervals for a predetermined duration.

31. The system of claim 30 where said system contains instructions for gathering information further comprises at least one of collecting the data from a party manufacturing the product, a party selling the product, a party promoting a product, or a party purchasing the product for resale.

32. The system of claim 30 where said system contains instructions for generating an audio message using a predetermined vocal persona.

33. The system of claim 30 where said system contains instructions for:
accessing a knowledge base based on the reviewed information;
associating reviewed information with appropriate dialogue from the knowledge base, and;
creating a message based on gathered information.

34. The system of claim 30 where said system contains instructions for:
accessing information gathered on the product's use;
determining times for future contacts based on the accessed information; and
creating the message based on said accessed information.

35. A computer usable medium having a computer readable program code means embodied therein for a manufacturer to supply an end user with information on the client's product with an automated message, the computer usable medium comprising:
a computer readable program code means for reviewing information relating to an end user's use of a product, wherein the end user is targeted to be contacted based on that use;
a computer readable program code means for gathering information based on the reviewed information regarding an end user's use of a product to be communicated to the end user; and
a computer readable program code means for communicating to the end user gathered information relating to proper use of the product via an automated message system, wherein the gathered information is communicated to the end user at predetermined intervals for a predetermined duration.

36. The computer usable medium of claim 35 for gathering information further comprises the step of collecting the data from a party manufacturing the product, a party selling the product, a party promoting a product, or a party purchasing the product for resale.

37. The computer usable medium of claim 35 further comprising the steps of generating an audio message using a predetermined vocal persona.

38. The computer usable medium of claim 35, wherein the steps for gathering information further containing instructions for:
accessing a knowledge base based on the reviewed information;
associating reviewed information with appropriate dialogue from the knowledge base, and;
creating a message based on gathered information.

39. The computer usable medium of claim 35 further containing instructions for:
accessing information gathered on the product's use;
determining times for future contacts based on the accessed information; and
creating the message based on said accessed information.
